(19) United States
(12) Patent Application Publication
(10) Pub. No.: US 2015/0075473 A1
(43) Pub. Date: Mar. 19, 2015

(54) GLOW PLUG AND METHOD FOR MANUFACTURING SAME

(71) Applicant: NGK SPARK PLUG CO., LTD., Nagoya-shi, Aichi (JP)

(72) Inventors: Takayuki Osawa, Iwakura-shi (JP); Shuei Ishii, Nagoya-shi (JP)

(73) Assignee: NGK SPARK PLUG CO., LTD., Nagoya-shi, Aichi (JP)

(21) Appl. No.: 14/387,640

(22) PCT Filed: Mar. 6, 2013
(86) PCT No.: PCT/JP2013/001380

§ 371 Date: Sep. 24, 2014

(30) Foreign Application Priority Data
Mar. 29, 2012 (JP) 2012-075292

(51) Int. Cl. F02P 19/02; F23Q 7/00

(52) U.S. Cl. CPC F02P 19/021; F23Q 7/001; F23Q 2007/004
USPC 123/145 A; 123/179.21; 29/611

(57) ABSTRACT

A glow plug includes a cylindrical housing having an axial hole and provided with a screw portion, and a heater member which is inserted into the axial hole in a state where at least a front end portion thereof projects from a front end of the housing. The housing includes a pressure contact portion brought into pressure contact with a seat surface of an internal combustion engine when the screw portion is screwed into a mounting hole of the internal combustion engine, and a cylindrical front-end-side body portion provided between the pressure contact portion and the screw portion. The front-end-side body portion includes a holding portion which holds the heater member directly or indirectly at an inner circumference thereof, and the holding portion has a smallest outer diameter in the front-end-side body portion.

### TECHNICAL FIELD

The present invention relates to a glow plug used to preheat a diesel engine and the like, and a method for manufacturing the same.

### BACKGROUND ART

Glow plugs, which are used in assisting a start of an internal combustion engine such as a diesel engine, include a tubular housing, a heater member which is energized to be heated, and the like. As the heater member, a ceramic heater having a heating element made of a conductive ceramic and a sheathed heater having a heating coil are adopted from time to time.

In addition, the housing includes a mounting screw portion for mounting to the internal combustion engine and a pressure contact portion which is brought into pressure contact with a seat surface provided to the internal combustion engine when the screw portion is screwed into a mounting hole in the internal combustion engine to ensure gastightness in a combustion chamber. Further, a portion (a front-end-side body portion) of the housing which is located between the screw portion and the pressure contact portion includes a holding portion which has a smallest hole diameter in the front-end-side body portion and which holds the heater member at an inner circumference thereof. It is noted that an outer diameter of the front-end-side body portion is generally constant along the direction of an axis of the housing and that the holding portion has a largest thickness in the front-end-side body portion (for example, refer to Patent Literature 1 or the like).

Incidentally, with the glow plug mounted to the internal combustion engine, a compression force (an axial force) is applied to the front-end-side body portion along the direction of the axis. Because of this, there are fears that the front-end-side body portion is deformed so as to expand radially outwards by the axial force. In the event that such deformation is generated, there are fears that the holding force for holding the heater member by the holding portion is reduced. Then, in general, the thickness of the front-end-side body portion is made relatively large to prevent the radially outward deformation of the front-end-side body portion while ensuring the sufficient strength of the front-end-side body portion.

### PRIOR ART LITERATURE

### Patent Literature

Patent Literature 1: JP-A-2009-162409

### SUMMARY OF THE INVENTION

### Problem that the Invention is to Solve

However, in the event that the thickness of the front-end-side body portion is made large as described above, in cooperation with the fact that the thickness is increased locally at the holding portion, the weight of the housing and hence of the glow plug is increased, whereby a deterioration in fuel economy may be caused. In addition, in manufacturing the housing, the amount of material used for manufacturing the housing is increased, resulting in fears that the manufacturing costs are increased to a relatively high level. Further, since the heat of the heater member is conducted largely to the side of the front-end-side body portion due to the front-end-side body portion (the holding portion) which holds the heater member being made thick, there are fears that the quick temperature rising characteristic of the heater member is deteriorated and that electric power necessary to allow the heater member to reach a predetermined temperature is increased.

The invention has been made in view of these situations, and an object thereof is to provide a glow plug which can realize an improvement in fuel economy, a reduction in manufacturing costs, an improvement in quick temperature rising characteristic and a conservation of electric power, while preventing the reduction in the holding force for holding the heater member by the holding portion.

### Means for Solving the Problem

Hereinafter, configurations suitable for achieving the object will be described item by item. It is noted that specific working effects to the configurations will additionally be described as required.

Configuration 1.

A glow plug according to this configuration is a glow plug including:

a cylindrical housing having an axial hole which extends in a direction of an axis and provided with, on an outer circumferential surface thereof, a screw portion for being screwed into a mounting hole of an internal combustion engine; and

a heater member inserted into the axial hole in a state where at least a front end portion thereof projects from a front end of the housing,

characterized in that:

the housing includes:
a pressure contact portion brought into pressure contact with a seat surface of the internal combustion engine when the screw portion is screwed into the mounting hole of the internal combustion engine; and
a cylindrical front-end-side body portion provided between the pressure contact portion and the screw portion, the front-end-side body portion including a holding portion which holds the heater member directly or indirectly at an inner circumference thereof, and

the holding portion has a smallest outer diameter in the front-end-side body portion.

Configuration 2.

The glow plug according to this configuration is characterized in that, in the above-described Configuration 1, the front-end-side body portion has a uniform thickness

It is noted that the “uniform thickness” includes not only a case where thicknesses at portions of the front-end-side body portion are strictly the same, but also a case where the thicknesses at the portions of the front-end-side body portion differ slightly (for example, by 0.1 mm or smaller).

Configuration 3.

The glow plug according to this configuration is characterized in that, in the above-described Configuration 1 or 2, either of the following (a) or (b) is satisfied.

(a) a thread diameter of the screw portion is M12, and a thickness of the front-end-side body portion is 1.6 mm or thinner;

(b) the thread diameter of the screw portion is M10, M9 or M8, and the thickness of the front-end-side body portion is 0.9 mm or thinner.

Configuration 4.

The glow plug according to this configuration is characterized in that, in any one of the above-described Configurations 1 to 3, the heater member is held by the holding portion by being press fitted in the inner circumference of the holding portion.

Configuration 5.

The glow plug according to this configuration is characterized in that, in any one of the above-described Configurations 1 to 4, an outer diameter of the front-end-side body portion reduces gradually from a front end of the screw portion towards the holding portion and increases gradually from the holding portion towards a rear end of the pressure contact portion.

Configuration 6.

A method for manufacturing the glow plug according to this configuration is a method for manufacturing the spark plug described in any one of the above-described Configurations 1 to 5, the method including:

a housing forming process of forming the housing,

characterized in that:

the housing forming process includes a step of forming a cylindrical housing intermediate product, which is to become the housing, by performing deep drawing processing to a plate-shaped metal material.

### Effect of the Invention

According to the glow plug of the Configuration 1, the holding portion has the smallest outer diameter in the front-end-side body portion. Consequently, when an axial force is applied to the front-end-side body portion, the axial force is decomposed towards the front-end-side body portion. Because of this, it is possible to prevent the reduction in holding force for holding the heater member by the holding portion in a more ensured fashion. Additionally, the presence of the heater member can prevent the radially inward deformation of the front-end-side body portion.

In addition, since the reduction in holding force can be prevented, the thickness of the front-end-side body portion does not have to be made large, thereby making it possible to realize the reduction in thickness of the front-end-side body portion. Additionally, since the holding portion has the smallest hole diameter in the front-end-side body portion, the holding portion is naturally made thin. Consequently, the weight of the housing can be reduced, thereby making it possible to realize the improvement in fuel economy. Further, the material necessary to manufacture the housing can be reduced, thereby making it possible to realize the reduction in manufacturing costs.

Additionally, the weight of the front-end-side body portion which holds the heater member (the holding portion) can be reduced, whereby the heat of the heater member which is conducted towards the front-end-side body portion can be reduced. As a result, the temperature of the heater member can be raised quickly with a smaller supply of electric power.

According to the glow plug of the Configuration 2, the thickness of the front-end-side body portion is uniform. Namely, the front-end-side body portion has the same thickness over the whole area thereof as the thickness of the holding portion which is relatively thin. Consequently, the weight of the housing can be reduced further, whereby the working effect in terms of improved fuel economy and reduced manufacturing costs can be exhibited more effectively.

According to the glow plug of the Configuration 3, the front-end-side body portion can be made thin sufficiently, whereby the weight of the housing can be reduced further. Consequently, the working effect in terms of improved fuel economy and reduced manufacturing costs can be exhibited far more effectively.

Conventionally, when the heater member is held by the holding portion by press fitting the heater member in the holding portion, a difference in diameter between the hole diameter of the holding portion and the outer diameter of the heater member is made large, whereafter the heater member is press fitted in the holding portion with a large force so as to ensure a sufficient holding force for holding the heater member. Consequently, the damage or failure of the heater member tends to be generated easily at the time of press fitting. On the other hand, in the event that the difference in diameter is made relatively small, whereafter the heater member is press fitted in the holding portion with a small force, although the damage or the like of the heater member can be suppressed, there are fears that the holding force for holding the heater member becomes insufficient.

In this respect, according to the Configuration 1 and the like, when an axial force is applied to the front-end-side body portion, the axial force is decomposed radially inwards (that is, towards the heater member). Namely, the axial force is decomposed in a direction in which the holding force for holding the heater member is increased further. Consequently, the holding force for holding the heater member should be a minimum required to ensure an extent to which the relative movement of the heater member to the housing is prevented when the glow plug dismounted from the internal combustion engine. Then, when the heater member is press fitted as with the glow plug according to the Configuration 4, the heater member does not have to be press fitted in the holding portion with the large force any more. As a result, the damage or failure of the heater member which would otherwise be generated at the time of press fitting can be prevented in a more ensured fashion.

According to the glow plug of the Configuration 5, the front-end-side body portion is configured so that the outer diameter thereof changes moderately along the direction of the axis and hence that the outer diameter thereof does not change drastically. Consequently, when an axial force is applied, it is possible to suppress a local application of a large force to a part of the front-end-side body portion. As a result, the deformation of the front-end-side body portion by the axial force can be prevented in a far more ensured fashion.

According to the method for manufacturing the glow plug of the Configuration 6, the housing intermediate product which is to become the housing is manufactured by deep drawing processing. Consequently, the housing can easily be manufactured which is thin as a whole and which is light in weight, thereby making it possible to realize an improvement in productivity.

In addition, since the housing can be made thin as a whole, it is possible to realize a further reduction in weight of the housing. As a result, the working effect in terms of improved fuel economy and reduced manufacturing costs can be enhanced further.

### BRIEF DESCRIPTION OF DRAWINGS

FIG. 1 is a front view of a glow plug.

FIG. 2 is a partially cutaway front view of the glow plug.

In FIG. 3, (a) is a perspective view of a metal material, (b) to (d) are front views showing a transition of the shape of the metal material through deep drawing processing, and (e) is a front view showing a housing intermediate product.

In FIG. 4, (a) is a partially cutaway front view showing a die and a punch which are used in forming a tool engagement portion, and (b) is a partially cutaway front view showing the die in which the housing intermediate product is disposed and the like.

In FIG. 5, (a) is a partially cutaway front view showing one step of a tool engagement portion forming process, and (b) is a front view showing the housing intermediate product on which the tool engagement portion is formed.

In FIG. 6, (a) is a sectional view showing a split mold which is used in forming a holding portion and the like, and (b) is a planar view of the split mold.

In FIG. 7, (a) is a sectional view showing the split mold where a housing intermediate product is disposed in an inner circumference thereof, (b) is a sectional view showing the pressing of the housing intermediate product by the split mold, and (c) is a front view showing the housing intermediate product in which a holding portion is formed.

FIG. 8 is a front view showing the configuration of a glow plug according to another embodiment.

FIG. 9 is a sectional view of the glow plug according to another embodiment.

### MODE FOR CARRYING OUT THE INVENTION

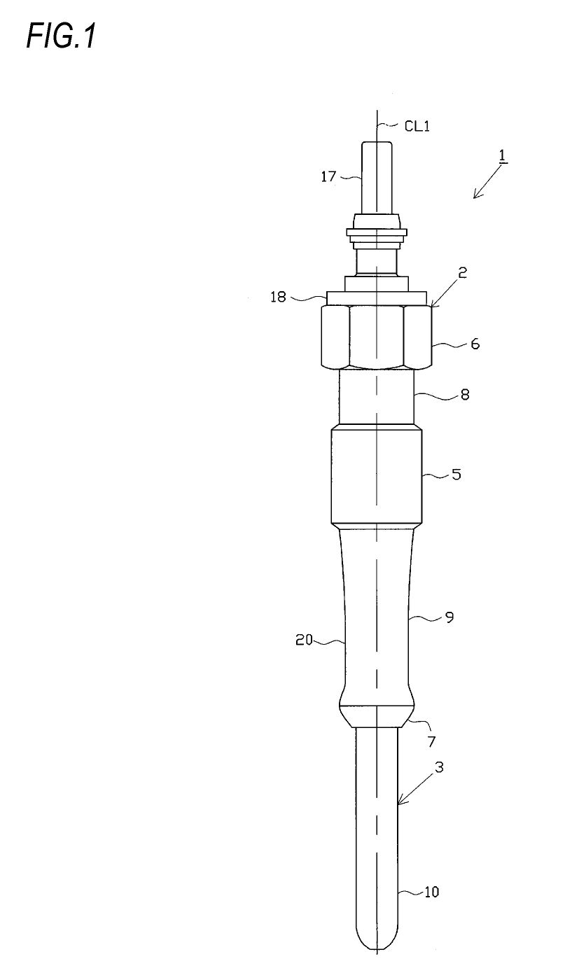

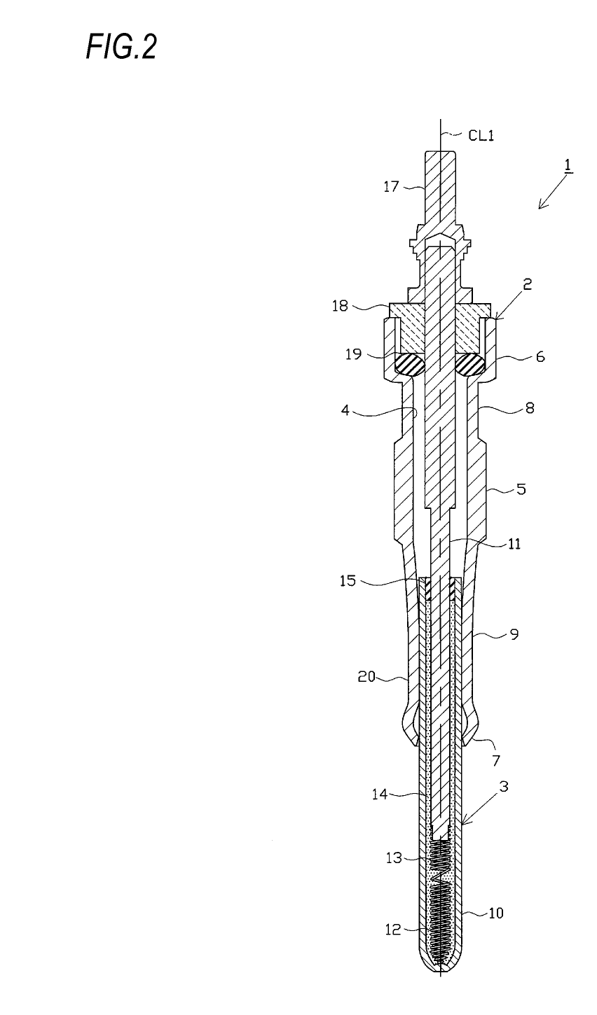

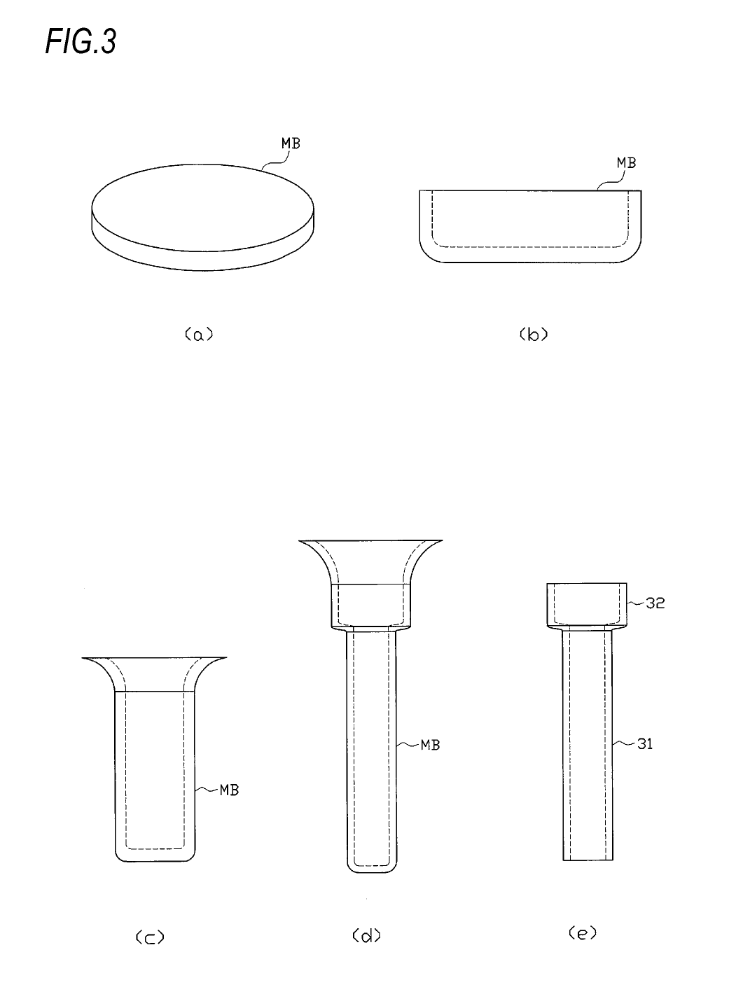

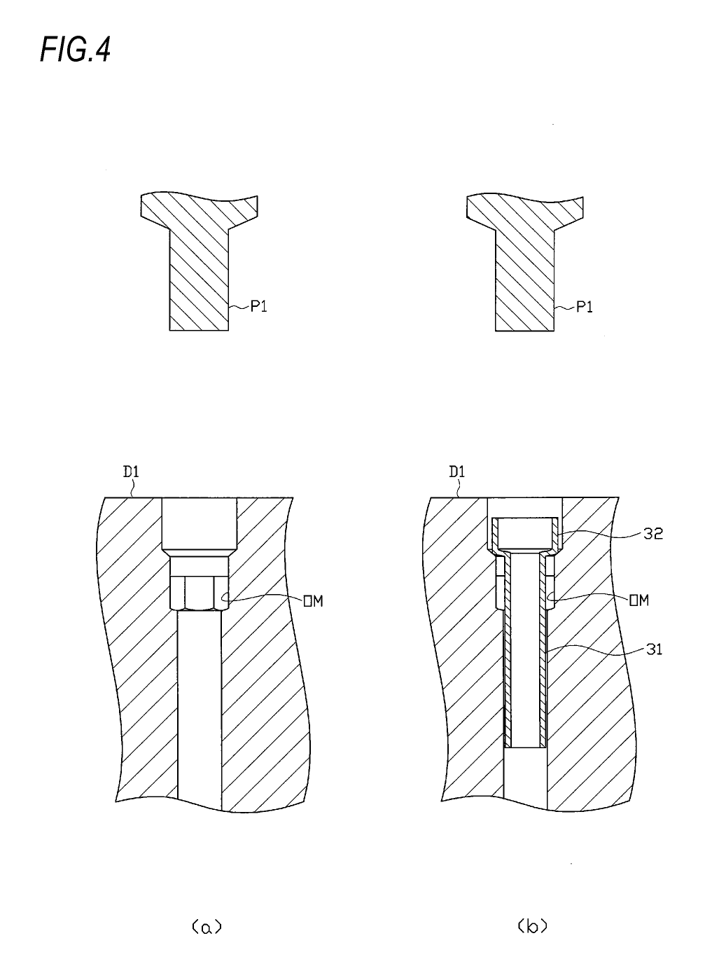

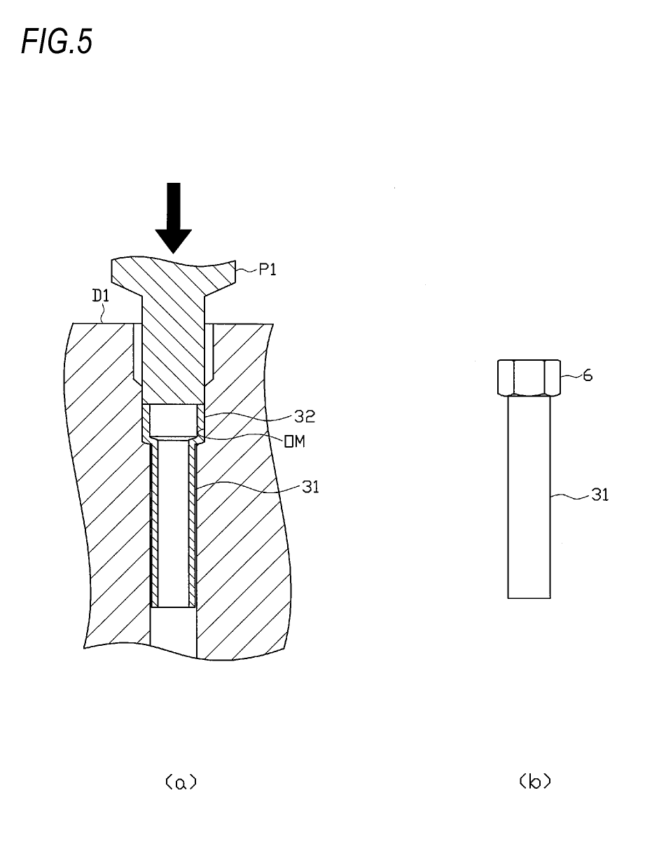

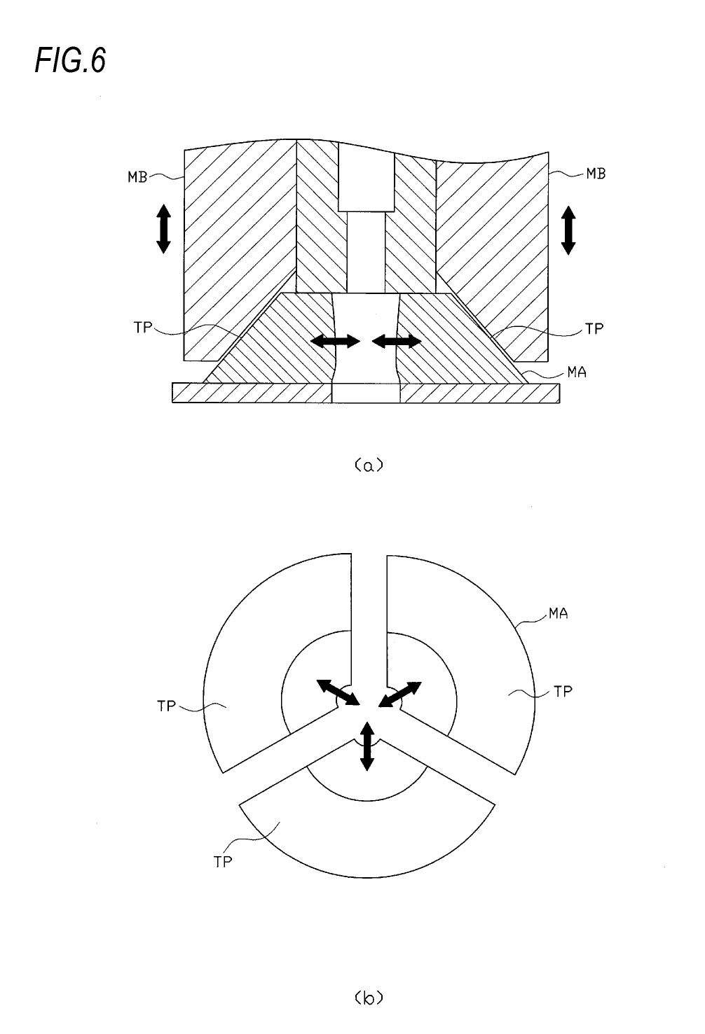

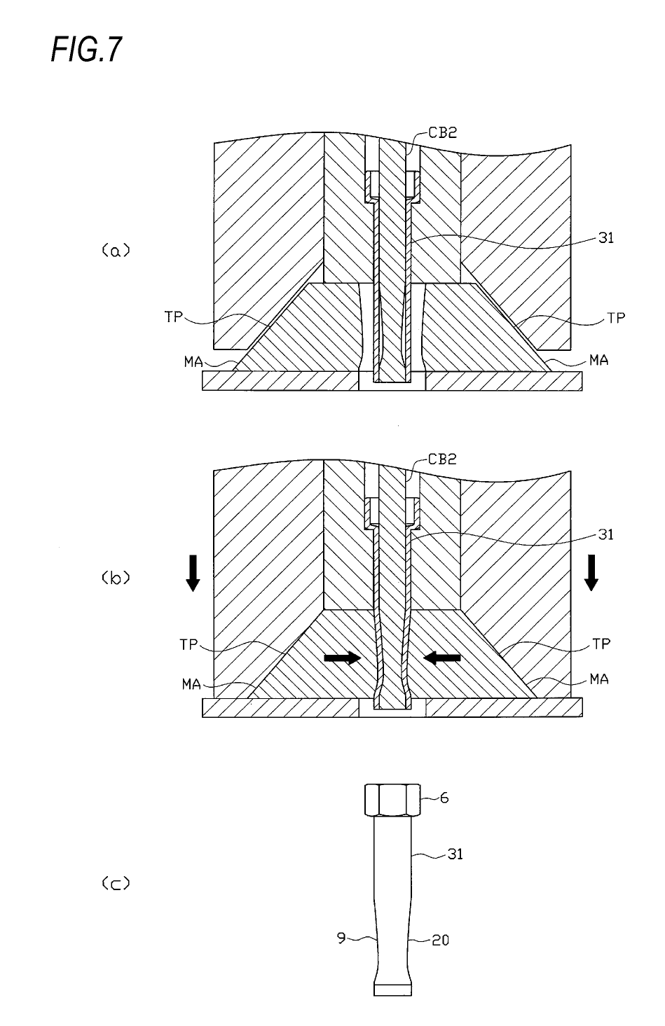

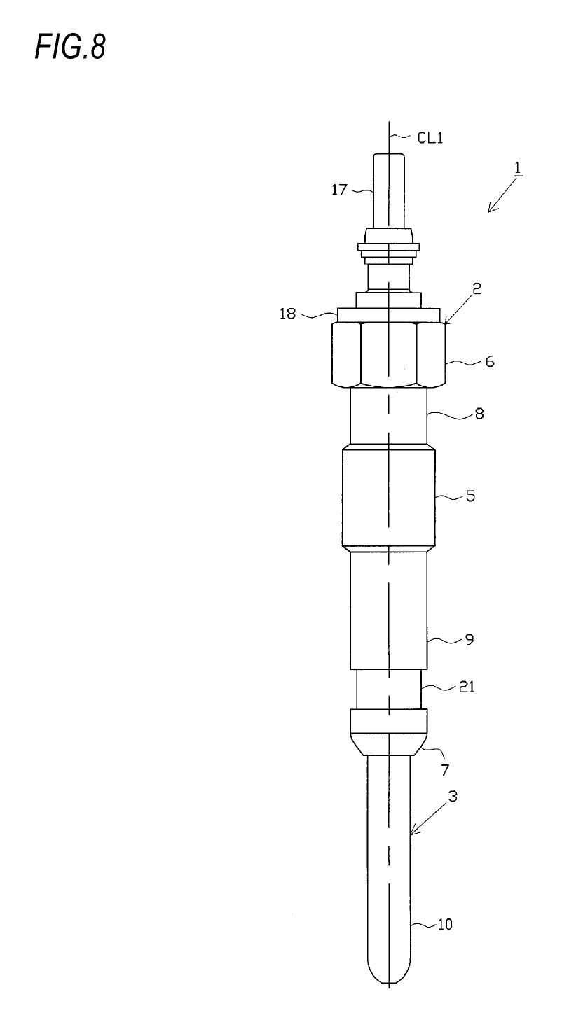

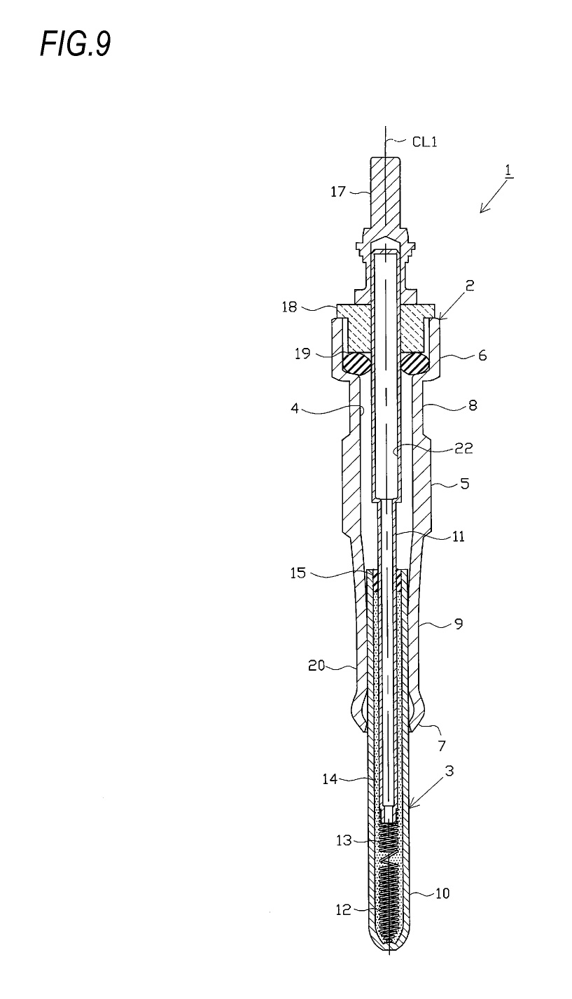

Hereinafter, referring to the drawings, an embodiment will be described. FIG. 1 is a front view of a glow plug 1, and FIG. 2 is a partially cutaway front view of the glow plug 1. In FIG. 1 and the like, a direction of an axis CL1 of the glow plug 1 will be referred to as a vertical direction in the figures, and a lower side will be referred to as a front end side, whereas an upper side will be referred to as a rear end side of the glow plug 1.

As shown in FIGS. 1 and 2, the glow plug 1 includes a cylindrical housing 2 and a heater member 3 which is mounted to the housing 2.

The housing 2 is formed of a predetermined metal (for example, carbon steel, stainless steel or the like) and has an axial hole 4 which penetrates therethrough in the direction of the axis CL1. In addition, a screw portion 5 for being screwed into a mounting hole of an internal combustion engine such as a diesel engine or the like and a tool engagement portion 6 having a hexagonal cross section to which a tool such as a torque wrench or the like is brought into engagement when the glow plug 1 is mounted in the internal combustion engine are formed on an outer circumferential surface of the housing 2. It is noted that in this embodiment, the screw portion 5 has a thread diameter of M12. Additionally, an inner circumference of the tool engagement portion 6 is formed into a hexagonal shape in section which follows an outer circumferential shape of the tool engagement portion 6.

Further, the housing 2 includes a pressure contact portion 7 at a front end portion thereof which is brought into pressure contact with a seat surface (not shown) of the internal combustion engine when the screw portion 5 is screwed into the mounting hole. The pressure contact portion 7 has a tapered shape in which an outer diameter thereof gradually reduces as it extends to the front end side, and gastightness is ensured in a combustion chamber by the pressure contact portion 7 being brought into pressure contact with the seat surface. In addition, the housing 2 includes a rear-end-side body portion 8 which is located between the screw portion 5 and the tool engagement portion 6 and a front-end-side body portion 9 which is located between the pressure contact portion 7 and the screw portion 5. The rear-end-side body portion 8 is formed into a cylindrical shape and has an outer diameter which is constant along the direction of an axis CL1. The front-end-side body portion 9 will be described in detail later. Additionally, in this embodiment, the housing 2 is thin as a whole and has an almost uniform thickness.

The heater member 3 includes a tube 10, a heating coil 12 and a control coil 13 which are disposed in an interior of the tube 10 and is connected in series with a center pole 11 which is made of a predetermined metal (for example, an iron-based alloy or the like).

The tube 10 is formed of a metal containing iron (Fe) or nickel (Ni) as a main composition (for example, a nickel-based alloy, a stainless steel alloy or the like) and is a cylindrical tube which is closed at a front end portion thereof. Additionally, the heating coil 12 which is joined to a front end of the tube 10 at a front end portion thereof and the control coil 13 which is connected in series with a rear end portion of the heating coil 12 are sealed in an inside of the tube 10 together with insulation powder 14 which contains magnesium oxide powder. Although the heating coil 12 electrically conducts with the tube 10 at a front end thereof, outer circumferential surfaces of the heating coil 12 and the control coil 13 and an inner circumferential surface of the tube 10 are insulated from each other by the insulation powder 14 interposed therebetween.

Further, an annular rubber 15 which is made of a predetermined rubber (for example, a silicone rubber or fluororubber or the like) is provided between an inner circumference of a rear end side of the tube 10 and the center pole 11, whereby the interior of the tube 10 is sealed.

The heating coil 12 is configured by winding a resistance heating wire which is made of a predetermined metal (for example, an alloy containing Al, Cr or the like in addition to Fe as a main composition, or the like) into a spiral shape. The heating coil 12 generates heat by being energized via the center pole 11.

In addition, the control coil 13 is configured by a material having a larger temperature coefficient of an electric specific resistance than that of the material of which the heating coil 12 is made, for example, a resistance heating wire which contains as a main composition Co or Ni which is represented by a cobalt (Co)—Ni—Fe based alloy or the like. By being so made, the control coil 13 increases an electric resistance value by generating heat in itself and receiving heat generated by the heating coil 12 therefrom to thereby control electric power supplied to the heating coil 12. Specifically, a relatively large magnitude of electric power is supplied to the heating coil 12 at an initial stage of energization, whereby the temperature of the heating coil 12 is raised. Then, the control coil 13 is heated as a result of the heating coil 12 being so heated, and this increases the electric resistance value of the control coil 13, whereby the supply of electric power to the heating coil 12 is reduced. The temperature rising characteristic of the heater member 3 is such that the temperature of the heater member 3 rises quickly at the initial stage of energization, whereafter the temperature thereof does not increase any further by the supply of electric power being suppressed by the action of the control coil 13. Namely, the existence of the control coil 13 makes it difficult for an excessive rise (an overshoot) in temperature of the heating coil 12 to occur while enhancing the quick temperature raising characteristic of the heater member 3.

The center pole 11 takes the form of a solid rod and a front end portion thereof is inserted into the interior of the tube 10. Then, with a frontmost end portion of the center pole 11 inserted in a rear end portion of the control coil 13, the center pole 11 and the control coil 13 are resistance welded together, whereby the center pole 11 and the control coil 13 are connected together.

Further, a cable connecting terminal pin 17 having a bottomed cylindrical shape is fixed to a rear end portion of the center pole 11 through crimping.

Additionally, an insulation bush 18 which is made of an insulation material is provided between a front end portion of the terminal pin 17 and a rear end portion of the housing 2 so as to prevent a direct energization (short-circuiting) between the terminal pin 17 and the housing 2.

In addition, with a view to realizing an improvement in gastightness in the axial hole 4, an annular seal member 19 which is made of an insulation material is provided between the housing 2 and the center pole 11 so as to be brought into contact with a front end portion of the insulation bush 18.

Next, the configuration of the front-end-side body portion 9 will be described in detail. In this embodiment, the front-end-side body portion 9 has a smallest inner diameter in the axial hole 4 and includes a holding portion 20 which holds the heater member 3 at an inner circumference thereof. Then, the heater member 3 is press fitted in the holding portion 20 in such a state that a front end portion thereof projects from a front end of the housing 2 to thereby be fixed to the housing 2.

Additionally, in this embodiment, the front-end-side body portion 9 is configured so that an outer diameter thereof reduces gradually from a front end of the screw portion 5 towards the holding portion 20 while the outer diameter increases from the holding portion 20 towards a rear end of the pressure contact portion 7, the holding portion 20 having a smallest outer diameter in the front-end-side body portion 9.

In addition, the front-end-side body portion 9 has a uniform thickness, which is 1.6 mm or thinner. It is noted that when a thread diameter of the screw portion 5 is M8, M9, or M10, the thickness of the front-end-side body portion 9 is 0.9 mm or thinner. However, it is preferable that the thickness of the front-end-side body portion 9 is equal to or larger than a predetermined value (for example, 0.3 mm) in order to prevent an excessive reduction in mechanical strength of the front-end-side body portion 9.

Next, a method for manufacturing the glow plug 1 which is configured as has been described heretofore will be described. It is noted that a conventionally known method is adopted for portions which will not be described specifically.

Firstly, a resistance heating wire containing Cr or Al in addition to Fe as a main composition is processed into a coil shape to obtain the heating coil 12. Additionally, a rear end portion of the heating coil 12 and a front end portion of the control coil 13 which is formed by processing a resistance heating wire of a Co—Ni—Fe based alloy into a coil shape are joined together through arc welding or the like.

Next, a front end of the center pole 11 and the heating coil 12 and the control coil 13 which are integrated with a front end of the center pole 11 are disposed within the cylindrical tube 10 which is formed larger in diameter by a working margin than a final dimension thereof and of which a front end is not closed. Then, a front end portion of the tube 10 is closed and the front end portion of the tube 10 and a front end portion of the heating coil 12 are joined together through arc welding.

Thereafter, after the insulation powder 14 is filled in the tube 10, the tube 10 is swaged to obtain the heater member 3 into which the tube 10 and the center pole 11 are integrated.

Next, in a housing forming process, the housing 2 is manufactured. Firstly, as shown in FIG. 3(a), a circular disk-shaped metal material MB which is made of a predetermined iron-based material is prepared, and deep drawing processing is performed to the metal material MB to obtain a cylindrical housing intermediate product which is to become the housing 2. Specifically, the metal material MB is supplied to a transfer press (not shown) in which a plurality of rod-shaped punches (not shown), which have different outer diameters getting smaller in a gradual fashion, and a plurality of bottomed cylindrical dies (not shown), which have different hole diameters corresponding to the outer diameters of the punches, are mounted to be aligned with each other. Then, the metal material MB is pressed in a plurality of stages by using the punches and the dies, whereby the metal material MB is formed into a cylindrical shape and the depth of the cylindrical shape is gradually increased as shown in FIGS. 3(b) to (d). Then, finally, both end portions of the metal material MB are cut to thereby obtain a cylindrical housing intermediate product 31 with a generally uniform thickness as a whole as shown in FIG. 3(e). The housing intermediate product 31 has an engagement-portion corresponding portion 32 at one end thereof. The engagement-portion corresponding portion 32 has a relatively large diameter that corresponds to a tool engagement portion 6.

Next, as shown in FIG. 4(a), by using a die D1 which has on an inner circumference thereof an outer circumference forming portion OM which has a shape corresponding to an outer circumferential shape of the tool engagement portion 6 and a vertically movable punch P1, the tool engagement portion 6 is formed. To describe this in detail, firstly, as shown in FIG. 4(b), the housing intermediate product 31 is disposed in an inner circumference of the die D1. Then, as shown in FIG. 5(a), the punch 1 is lowered, so that the engagement-portion corresponding portion 32 is pushed into the outer circumference forming portion OM in the die D1 by the punch P 1. By doing so, both an outer circumference and an inner circumference of the engagement-portion corresponding portion 32 are formed into a hexagonal shape in section, whereby a tool engagement portion 6 is formed as shown in FIG. 5(b).

Next, as shown in FIGS. 6(a), (b), the holding portion 20 is formed by using an annular split mold MA which is divided into a plurality of mold pieces along a circumferential direction and which can move along a radial direction. An inner circumferential surface of the split mold MA is formed into a curved surface which follows an outer circumferential shape of the front-end-side body portion 9, while an outer circumferential surface of the split mold MA is formed into a tapered portion TP having an inclined surface. Then, the split mold MA is moved radially inwards by pressing the tapered portion TP by a movable mold MB which can move along a direction which intersects a radial direction of the split mold MA at right angles. In addition, the split mold MA is biased radially outwards by an elastic member or the like, not shown, and is allowed to return to its original position by removing the pressure applied to the tapered portion TP by the movable mold MB.

Returning to the description of the manufacturing method, in forming the holding portion 20, firstly, as shown in FIG. 7(a), the housing intermediate product 31 is disposed in an inner circumference of the split mold MA, and a core metal CB 2 having a constriction which follows an inner circumferential shape of the front-end-side body portion 9 is disposed in an inner circumference of the housing intermediate product 31. Then, as shown in FIG. 7(b), a position of the housing intermediate product 31 where the front-end-side body portion 9 is expected to be formed is pressed from an outer circumferential side by the split mold MA. By doing so, a holding portion 20 is formed as shown in FIG. 7(c).

Thereafter, a screw portion 5 is formed at a predetermined portion of the housing intermediate product 31 through rolling. Further, a front end portion of the housing intermediate product 31 is pressed to be deformed in a curved fashion to thereby form a pressure contact portion 7, whereby a housing 2 is obtained.

Then, finally, the heater member 3 is press fitted in the holding portion 20 of the housing 2, and the insulation bush 18 and the seal member 19 are disposed on an outer circumference of a rear end portion of the center pole 11. Then, the terminal pin 17 is crimped and fixed to the rear end portion of the center pole 11, whereby the glow plug 1 is obtained.

Thus, as it has been described heretofore, according to the embodiment, the holding portion 20 has the smallest outer diameter in the front-end-side body portion 9. Consequently, when an axial force is applied to the front-end-side body portion 9, the axial force is decomposed towards the heater member 3. Because of this, the reduction in the holding force for holding the heater member 3 by the holding portion 20 can be prevented in an ensured fashion. Additionally, the presence of the heater member 3 can prevent the front-end-side body portion 9 from being deformed radially inwards.

Further, since the axial force is decomposed in a direction in which the holding force for holding the heater member 3 is increased, a minimal holding force for holding the heater member 3 is required. Consequently, in press fitting the heater member 3 in the holding portion 20, the heater member 3 does not have to be press fitted in the holding portion 20 with a large force. As a result, the damage or failure of the heater member 3 which would otherwise be caused when it is press fitted in the holding portion 20 can be prevented.

In addition, since the reduction in holding force for holding the heater member 3 can be prevented, the thickness of the front-end-side body portion 9 does not have to be thicker, and hence, the thickness of the front-end-side body portion 9 (the holding portion 20) can be 1.6 mm or thinner. Consequently, the weight of the housing 2 can be reduced sufficiently, thereby making it possible to realize an effective improvement in fuel economy. Further, since the amount of a material necessary to manufacture the housing 2 can be reduced remarkably, thereby making it possible to realize a large reduction in manufacturing costs.

Additionally, by reducing the weight of the front-end-side body portion 9 (the holding portion 20), the heat of the heater member 3 which is conducted towards the front-end-side body portion 9 can be reduced. As a result, it is possible to raise the temperature of the heater member 3 quickly with a smaller supply of electric power.

Additionally, in this embodiment, the thickness of the front-end-side body portion 9 is uniform, and the front-end-side body portion 9 has the same thickness over the whole area thereof as that of the holding portion 20 which is relatively thin. Consequently, a further reduction in the weight of the housing 2 can be realized, whereby the working effect in terms of improved fuel economy and reduced manufacturing costs can be exhibited more effectively.

In addition, the front-end-side body portion 9 is configured so that the outer diameter thereof changes gradually along the direction of the axis and hence does not change drastically. Consequently, it is possible to suppress a local application of a large force to part of the front-end-side body portion 9 in association with the application of an axial force thereto. As a result, the deformation of the front-end-side body portion 9 by the axial force can be prevented in a more ensured fashion.

Additionally, in this embodiment, since the weight of the housing 2 is reduced, it is possible to prevent more effectively the heat of the control coil 13 from being conducted to the housing 2. Consequently, the temperature and hence resistance value of the control coil 13 can be increased quickly. As a result, an original function of the control coil 13 to suppress the supply of electric power to the heating coil 12 can be exhibited quickly, and a further conservation of electric power can be realized.

Further, in this embodiment, deep drawing processing is performed to the plate-shaped metal material MB to manufacture the housing intermediate product 31 which is to become the housing 2. Consequently, it is possible to facilitate the manufacturing of the housing 2 which is thin and light in weight as a whole, thereby making it possible to realize an improvement in productivity.

The invention is not limited to what is described in the embodiment and, for example, may also be carried out in the following manners. Naturally, it is, of course, possible to adopt other application and modified examples which will not be exemplified below.

(a) In the embodiment described above, the front-end-side body portion 9 is configured so that the outer diameter thereof gradually reduces from the front end of the screw portion 5 towards the holding portion 20 and gradually increases from the holding portion 20 towards the rear end of the pressure contact portion 7. In contrast with this, as shown in FIG. 8, an outer diameter of a holding portion 21 may be smaller than an outer diameter of a portion of a front-end-side body portion 9 other than the holding portion 21, while the outer diameter of the portion other than the holding portion 21 is constant. As this occurs, too, in the event that an axial force is applied to the front-end-side body portion 9, the axial force is decomposed towards the heater member 3. Because of this, it is possible to prevent the reduction in holding force for holding the heater member 3 and the deformation of the front-end-side body portion 9 in an ensured fashion.

(b) In the embodiment described above, while the control coil 13 is interposed between the heating coil 12 and the center pole 11 to prevent the excessive rise in temperature or overshoot of the heating coil 12, the control coil 13 may be omitted by bringing the heating coil 12 into direct contact with the center pole 11.

(c) In the embodiment described above, the heater member 3 is configured by the tube 10 and the heating coil 12 and the like which are disposed in the interior of the tube 10, and in this respect, the technical concept of the invention is applied to the so-called metal glow plug. In contrast with this, the technical concept of the invention may be applied to a so-called ceramic glow plug in which a heater member is configured by a cylindrical base member which is made of an insulation ceramic and a heating element which is provided in the base member, which is made of a conductive ceramic and which is energized via the center pole 11 to generate heat. Additionally, in this case, a heater member may be used which includes a conductive film which is provided on an external surface of the base member to constitute a heating element (a so-called surface heating type heater). Further, at least part of the heating element may be formed of a conductive metal (for example, an alloy containing tungsten as a main composition) which has superior heat resistance.

(d) In the embodiment described above, while the rear end portion (the cable connecting portion) of the glow plug 1 is configured so that the terminal pin 17 is crimped and fixed to the rear end of the center pole 11, the configuration of the glow plug 1 is not limited thereto. Consequently, for example, a configuration may be adopted in which an external thread is provided on an outer circumference of a portion of the center pole 11 which projects from the rear end of the housing 2, and a nut having an internal thread on an inner circumference thereof is screwed on the external thread while the nut is in contact with the insulation bush 18, so that the rear end portion of the center pole projects from the nut. Namely, the rear end portion of the center pole may be configured as the cable connecting portion.

(e) In the embodiment described above, while the center pole 11 is formed as the solid rod-like member, as shown in FIG. 9, a hollow portion 22 may be provided in the center pole 11 so that the center pole 11 is formed into a tubular member. In this case, a further reduction in weight of the glow plug 1 can be realized, thereby making it possible to realize a further improvement in fuel economy.

Additionally, since the heat of the heater member 3 (the heating coil 12) conducted to the center pole 11 can be reduced, the heater member 3 (the heating coil 12) is allowed to reach the predetermined temperature more quickly, and also electric power necessary to allow the heater member 3 to reach the predetermined temperature can be reduced further.

Further, it is possible to effectively prevent the heat conduction from the control coil 13 to the center pole 11, whereby the temperature and hence resistance value of the control coil 13 can be increased more quickly. As a result, the control coil 13 allowed to exhibit its original function more quickly, and also a further conservation of electric power can be realized.

(f) In the embodiment described above, while the heater member 3 is held by the holding portion 20 by being press fitted in the holding portion 20, the holding form of the heater member by the holding portion is not limited thereto. Consequently, for example, the heater member may be held by joining the heater member to an inner circumference of the holding portion through brazing. Additionally, for example, an internal thread is formed on the inner circumference of the holding portion, while an external thread is formed on an outer circumference of the heater member, whereby the heater member may be held by screwing the heater member into the inner circumference of the holding portion.

Further, in the embodiment described above, while the heater member 3 is directly held by the holding portion 20, the heater member may be held indirectly by the holding portion via a predetermined member.

(g) In the embodiment described above, while the housing 2 is formed so that it is thin as a whole and has an almost uniform thickness, there is imposed no specific limitation on the thickness of the housing 2, and the thickness of the housing 2 may differ at portions thereof.

(h) In the embodiment described above, while the housing intermediate product 31 is formed through the deep drawing processing, the method for manufacturing the housing intermediate product 31 is not limited thereto. Consequently, for example, a predetermined metal material may be forged so as to obtain a housing intermediate product.

(i) There is imposed no specific limitation on the shape of the heater member 3, and hence, for example, the heater member 3 may have an elliptic cross-sectional shape or an oval cross-sectional shape, or a polygonal cross-sectional shape. In addition, a so-called plate heater in which a plurality of plate-shaped insulating base members are formed and a heating element is sandwiched therebetween may be used as the heater member.

(j) The materials described as configuring the heating coil 12 and the control coil 13 in the embodiment described above are only the examples, and hence, there is imposed no specific limitation on the material of which the heating coil 12 or the like is configured by.

### DESCRIPTION OF REFERENCE NUMERALS AND CHARACTERS

1 glow plug;
2 housing;
3 heater member;
4 axial hole;
5 screw portion;
7 pressure contact portion;
9 front-end-side body portion;
20 holding portion;
31 housing intermediate product;
CL1 axis;
MB metal material.

1. A glow plug comprising:
a cylindrical housing having an axial hole which extends in a direction of an axis and provided with, on an outer circumferential surface thereof, a screw portion for being screwed into a mounting hole of an internal combustion engine; and
a heater member inserted into the axial hole in a state where at least a front end portion thereof projects from a front end of the housing,
characterized in that:
the housing includes:
a pressure contact portion brought into pressure contact with a seat surface of the internal combustion engine when the screw portion is screwed into the mounting hole of the internal combustion engine; and
a cylindrical front-end-side body portion provided between the pressure contact portion and the screw portion, the front-end-side body portion including a holding portion which holds the heater member directly or indirectly at an inner circumference thereof,
the holding portion has a smallest outer diameter in the front-end-side body portion, and
an outer diameter of the front-end-side body portion reduces gradually from a front end of the screw portion towards the holding portion and increases gradually from the holding portion towards a rear end of the pressure contact portion.

2. The glow plug according to claim 1, characterized in that:
the front-end-side body portion has a uniform thickness.

3. The glow plug according to claim 1, characterized in that:
either of the following (a) or (b) is satisfied:
(a) a thread diameter of the screw portion is M12, and a thickness of the front-end-side body portion is 1.6 mm or thinner;
(b) the thread diameter of the screw portion is M10, M9 or M8, and the thickness of the front-end-side body portion is 0.9 mm or thinner.

4. The glow plug according to claim 1, characterized in that:
the heater member is held by the holding portion by being press fitted in the inner circumference of the holding portion.

5. (canceled)

6. A method for manufacturing the glow plug according to claim 1, the method comprising:
a housing forming process of forming the housing,
characterized in that:
the housing forming process includes a step of forming a cylindrical housing intermediate product, which is to become the housing, by performing deep drawing processing to a plate-shaped metal material.
